(19) United States
(12) Patent Application Publication
(10) Pub. No.: US 2005/0169452 A1
(43) Pub. Date: Aug. 4, 2005

(54) Method and apparatus for self-evaluation and randomization for predictive models

(75) Inventors: Sergey A. Prigogin, Foster City, CA (US); Michel Adar, Palo Alto, CA (US); Nicolas M. Bonnet, Palo Alto, CA (US)

Correspondence Address: BEYER WEAVER & THOMAS LLP, P.O. BOX 70250, OAKLAND, CA, 94612-0250, US

(73) Assignee: Sigma Dynamics, Inc.

(21) Appl. No.: 11/040,644

(22) Filed: Jan. 21, 2005

Related U.S. Application Data
(60) Provisional application No. 60/541,628, filed on Feb. 3, 2004.

(51) Int. Cl. G10L 15/00

(52) U.S. Cl. 379/265.01

(57) ABSTRACT

Disclosed are methods and apparatus for evaluating a certainty characteristic of a predictive model. When a decision needs to be implemented, the predictive model is utilized unless the certainty characteristic of such model indicates that the predictive model results are unacceptably uncertain and should not be used. Otherwise, the predictive model is used to reach a decision. In a further embodiment, randomization is introduced into the results of the predictive model (when utilized for a decision). The amount of randomization is tied to the amount of uncertainty of results of the model to thereby balance exploitation and exploration goals.

### CROSS REFERENCE TO RELATED PATENT APPLICATION

This application claims priority of U.S. Provisional Patent Application No. 60/541,628 (Attorney Docket No. SIGMP003P), entitled “SELF EVALUATION AND RANDOMINATION FOR PREDICTIVE MODELS”, filed 3 Feb. 2004 by Sergey A. Prigogin et al., which application is incorporated herein by reference in its entirety for all purposes.

### BACKGROUND OF THE INVENTION

The present invention relates to the general technical area of using prediction models to model interactions between various entities, such as a customer and a telephone call center. More specifically, it relates to evaluating the quality of prediction model and implementing procedures when the quality is unacceptable.

Consumers of products and services are increasingly using automated interaction channels such as Internet web sites and telephone call centers. Such automated sales channels typically provide an automated process which attempts to match potential customers with desirable products and/or services. In the case of web sites, the interaction channel may be fully automated. In the case of call centers, human customer-service agents are often used. One goal of the companies selling the products and services is to maximize total enterprise profitability and, therefore, companies will often invest heavily in creating computerized models in an attempt to maximize their revenue and minimize their expenses for both of these types of sales channels.

Prediction modeling is generally used to predict the outcome of numerous decisions which could be implemented. In a most simplistic example, a prediction model may predict the likelihood (or probability) of a particular result or outcome occurring if a particular action was performed (e.g., a particular decision is carried out) under one or more specific conditions. In a more complex scenario, a prediction model may predict the probabilities of a plurality of outcomes for a plurality of actions being performed under various conditions.

In a specific application, prediction modeling may be used to decide which specific interactions are to be taken by a company's service or product sales center (e.g., website or telephone call center) when a customer is interacting with such center. The prediction modeling helps the company select an interaction that is likely to result in a desirable goal being met. Automated sales centers, for example, typically provide an automated process which attempts to match potential or current customers with desirable products and/or services. In the case of websites, the sales center may be fully automated. In the case of call centers, human customer-service agents in conjunction with automated interactive voice recognition (IVR) processes or agents are often used.

For example, a customer may go to a particular website or call center of a company which specializes in selling automobiles. From the company's perspective, the company may have a goal of maximizing automobile revenue to each customer who interacts with its website or telephone call center. When a customer initially accesses the website or call center, it may be possible to select any number of sales promotions to present to the customer (e.g., via a web page or communicated by a human sales agent). Prediction models may be used to determine which sale promotion to present to a given customer to more likely achieve the goal of maximizing sales revenue. For instance, it may be determined that a particular type of customer is highly likely to buy a particular type of automobile if presented with a sales presentation for such item.

Although a prediction model may be reliably used under a number of conditions, in certain instances a prediction model may not present highly accurate results. When a self-learning type prediction model is still early in its learning process, it is possible to enter into a self-reinforcing cycle wherein less than optimal choices are reinforced because other alternatives are never tried. In order to address this issue, some self-learning models are provided with randomization features which force the models to try alternatives in order to broaden their experience. Unfortunately, such randomization techniques do not tend to address the fact that there must be a balance between exploration and exploitation in self-learning models. That is, while the model is still early in its learning process, it is acceptable to be more of an explorer to test random alternatives, but as the model gains in experience, it is important to exploit its knowledge to produce better results.

Unfortunately, randomization techniques are not always suitable or desirable in real world applications. Call center agents, in particular, tend to have a low tolerance for modeling systems that do not provide good alternatives on a regular basis. Furthermore, some call center agents are more particular than others, depending upon the products or services that they are providing. Human agents will tend to stop using systems that they feel are behaving erratically, such as by giving random, nonsensical alternatives. Therefore, randomization, if used at all, would of necessity be very limited in nature, possibly resulting in the aforementioned self-reinforcing cycle where the best alternatives may never be presented to the agent.

In view of the above, there is a need for improved mechanisms for determining whether the results of a prediction model are reliable or acceptable for the current conditions and mechanisms for providing alternative decision making techniques when a prediction model is found to be unacceptable. Additionally, techniques for introducing randomization into the prediction model results are also needed.

### SUMMARY OF THE INVENTION

Accordingly, methods and apparatus for evaluating a certainty characteristic of a predictive model are provided. When a decision needs to be implemented, the predictive model is utilized unless the certainty characteristic of such model indicates that the predictive model results are unacceptably uncertain and should not be used. Otherwise, the predictive model is used to reach a decision. In a further embodiment, randomization is introduced into the results of the predictive model (when utilized for a decision). The amount of randomization is tied to the amount of uncertainty of results of the model to thereby balance exploitation and exploration goals.

In one embodiment, a method of evaluating and using a self-learning predictive model is disclosed. The method includes (a) receiving a request for a decision; (b) determining confidence level of a self-learning predictive model that indicates whether the decision is to be based on the self-learning predictive model or not; (c) providing and implementing a decision based on an alternative prediction process that is independent of the prediction model when the confidence level indicates that the decision is not to be based on the self-learning predictive model; and (d) providing and implementing a decision based on one or more results produced by the prediction model when the confidence level indicates that the decision is to be based on the self-learning predictive model. In one aspect, the alternative prediction process is a plurality of business rules compiled by one or more people off-line from the decision making procedure.

In a specific implementation, the confidence level is determined automatically by the predictive model. In one aspect, the confidence level is a binary value having a first state that indicates that the decision is not to be based on the self-learning predictive model and a second state that indicates that the decision is to be based on the self-learning predictive model. In another aspect, the confidence level is a value having a range of zero to less than 1.0, and operation (c) is performed when the confidence level is less than or equal to a predetermined threshold and operation (d) is performed when the confidence level is greater than the predetermined threshold.

In a further embodiment, the method includes executing the predictive model to thereby produce a score that corresponds to a probability of a particular outcome occurring for a set of current conditions. The score is based on past outcomes under conditions that are similar to the current conditions. In a further implementation, the execution of the predictive model is only performed when the confidence level indicates that the decision is to be based on the self-learning predictive model. In another embodiment, execution of the predictive model produces a plurality of scores that correspond to a plurality of probabilities of different outcomes occurring for the set of current conditions.

In an alternative embodiment, the request for a decision originates from either an automated or a human-operated service center, and wherein the predetermined threshold is a higher value for a human-operated service center than an automated service center.

In yet another further embodiment, the method includes (i) executing the predictive model to thereby produce a plurality of results in the form of a plurality of scores that correspond to a plurality of probabilities of different outcomes occurring; and (ii) introducing randomization into the scores produced by the prediction model when the confidence level indicates that the decision is to be based on the self-learning predictive model. In one aspect, this randomization is introduced so as to balance between exploitation and exploration goals. In a further implementation, the amount of the randomization of each score is proportional to an inaccuracy amount of the each score. In yet another aspect, the inaccuracy amount of the each score is a standard deviation amount of the each score. In a specific implementation, a function of the randomization of each score is proportional to a prediction distribution function for the each score. In yet another embodiment, each score is more likely deviated within a range that corresponds to a range of standard deviation of the each score.

In another embodiment, the invention pertains to a computer system operable to evaluate and use a self-learning predictive model. The computer system includes one or more processors and one or more memory. At least one of the memory and processors are adapted to provide at least some of the above described method operations. In yet a further embodiment, the invention pertains to a computer program product for evaluating and using a self-learning predictive model. The computer program product has at least one computer readable medium and computer program instructions stored within at least one of the computer readable product configured to perform at least some of the above described method operations.

These and other features and advantages of the present invention will be presented in more detail in the following specification of the invention and the accompanying figures that illustrate by way of example the principles of the invention.

### BRIEF DESCRIPTION OF THE DRAWINGS

FIG. 1 is a diagrammatic representation of an exemplary first sales channel for which techniques of the present invention may be applied.

FIG. 2 is a diagrammatic representation of an exemplary second sales channel for which techniques of the present invention may be applied.

FIG. 3 is a diagram illustrating an exemplary distributed learning system in which techniques of the present invention may be implemented.

FIG. 4 is a flowchart illustrating a procedure for implementing a decision using a prediction model in accordance with one example application of the present invention.

FIG. 5 is a graph illustrating a lift curve and determination of confidence level in accordance with a specific implementation of the present invention.

FIG. 6 is a graph illustrating a first probability distribution 602 for a first decision choice and a second probability distribution 604 for a second decision choice.

FIG. 7 is a block diagram of a general purpose computer system suitable for carrying out the processing in accordance with one embodiment of the present invention.

### DETAILED DESCRIPTION OF SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

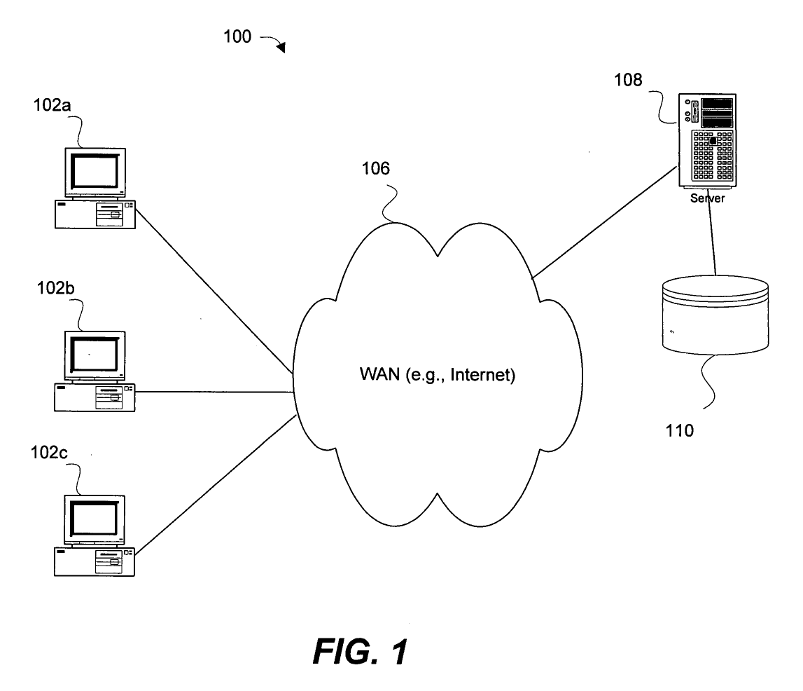

FIG. 1 is a diagrammatic representation of an exemplary first sales channel 100 for which techniques of the present invention may be applied. As shown, the sales channel 100 includes a plurality of hosts 102 and a web server 108 which are both coupled to a wide area network (WAN) 106, e.g., the Internet. Any suitable type of entity or user (such as a person or an automated process) may access the web server 108 via host device 102. The server 108 may also be in communication with one or more database 110. The web server 108 may be configured to provide various products and services to various users. For example, the web server 108 may include an on-line store for customers to purchase various products and an on-line service center for providing customers with FAQ's or trouble shooting help regarding their purchased products.

In a sales environment, potential customers on computers 102 or the like access the web server 108 via the Internet 106 or the like. Their experience at the website hosted by web server 108 is dictated or influenced by one or more prediction models running, for example, on the web server 108 and obtained from database 110, for example. The prediction model is preferably self-learning, at least based in part, on the interactions of the potential customers and the website. Information regarding the customers and website interactions is preferably stored in database 110. It should be noted that the computers, network, servers, databases, machines, etc. that are illustrated in FIG. 1 are logical in nature, and some are all of their functionalities can be performed on one or more physical machines, systems, media, etc.

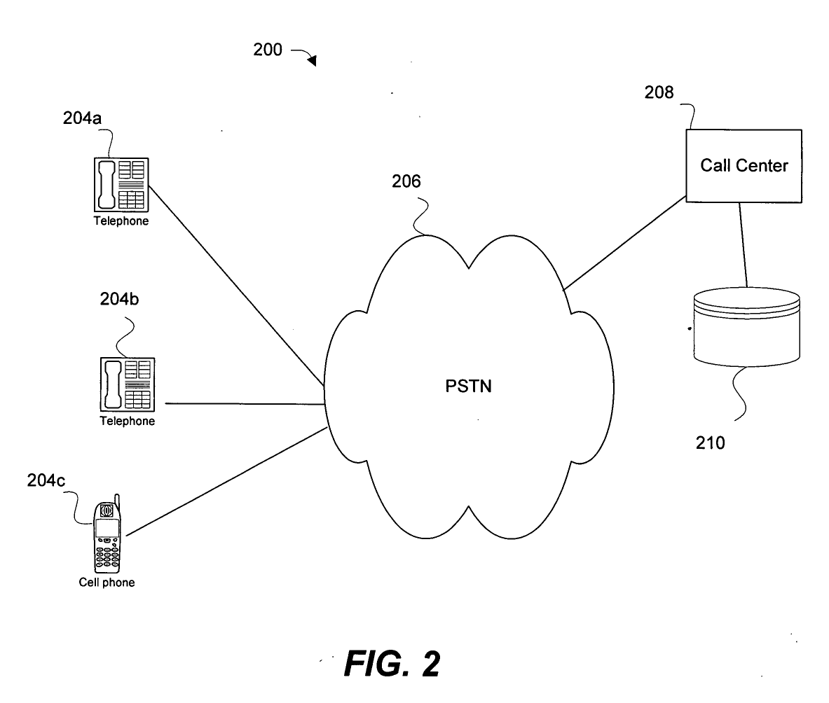

FIG. 2 illustrates an exemplary second sales channel 24 which has certain analogies with the exemplary first sales channel 100. In second sales channel 200, users may access call center 208 though individual telephones 204 or the like via a telephone system 206 (public switched telephone network or PSTN) or the like. The call center 208 may maintain a database 210 for essentially the same purposes that the web server 108 of FIG. 1 maintains the database 110 in the first sales channel 100. Users may communicate and interact with agents (human or automated) or an IVR system at the call center 108. Again, the telephones, telephone system, call center, and database, etc., of FIG. 2 are illustrated in a functional form and their actual physical manifestations may differ from implementation to implementation.

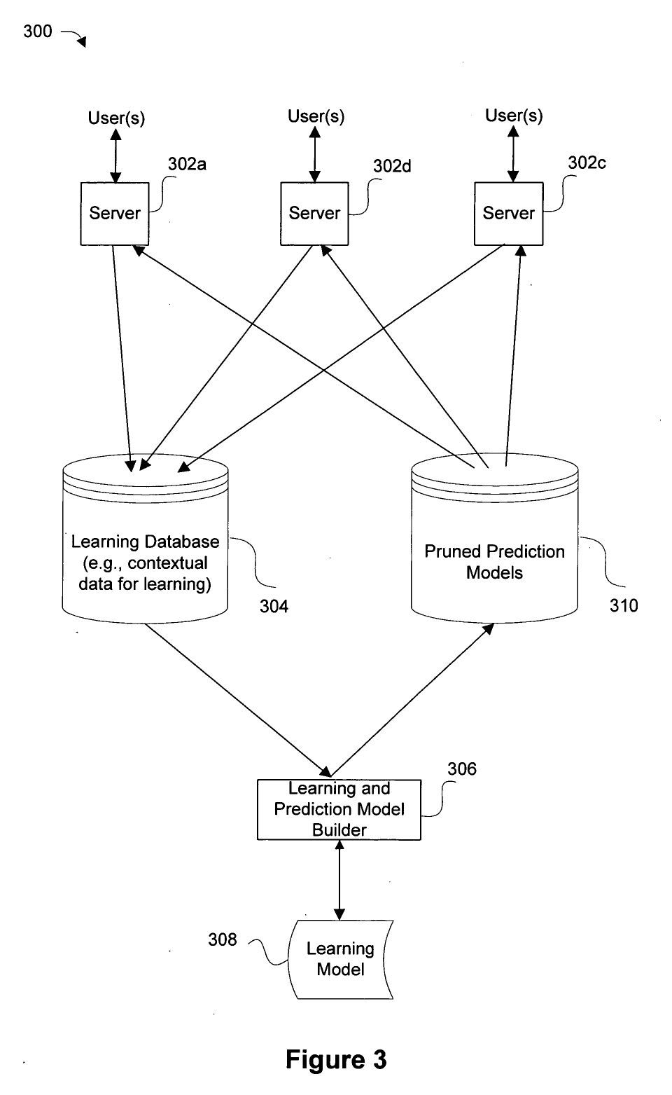

FIG. 3 is a diagram illustrating an exemplary distributed learning system 300 in which techniques of the present invention may be implemented. Of course, the present invention may be implemented in any suitable system that implements predictive modeling. As shown in FIG. 3, system 300 includes one or more interactive servers 302, a learning database 304, a prediction model repository 310, a learning and prediction model builder server 306, and a learning model 308. The learning system preferably includes a plurality of distributed interactive servers 302 although a single interactive server is also contemplated.

Interactive servers 302 execute one or more prediction models to determine specific transaction paths to follow, such as which web page or automated interactive voice message to present to a particular customer. A single prediction model may be used to predict the probability of a particular outcome or any number of outcomes based on a specific number of input attributes or contextual data and their corresponding values. Contextual data is in the form of a finite set of input factors which are deemed to have an effect on whether a particular goal or outcome is met when particular decisions or events occur. Input attributes may include attributes of a contacting entity (such as a potential or current customer), attributes of an answering entity (such as sales or service agent), time information regarding when specific events occur, etc. Alternatively, a plurality of prediction models may be used to determine the probability of a plurality of outcomes. Each single prediction model may be used to predict each single outcome probability. For example, a first prediction model may be used to determine the probabilities of achieving a first outcome when a particular decision (or action plan) is implemented with respect to various customer's with specific characteristics or profiles, and a second prediction model is used to determine the probabilities of achieving a second outcome when a particular decision (or action plan) is implemented with respect to various customer's with specific characteristics or profiles. In sum, any number of prediction models may be used to predict any number of outcomes under any number of different input attribute values.

The prediction models may be retrieved from (or sent by) one or more prediction models database 310. The interactive servers 302 also may be configured to collect contextual data regarding the input attributes used in the prediction model, as well as the results of the selected interaction or decision path. This contextual data is collected from one or more interactive servers 302 and stored in learning database 304.

Learning and prediction model builder 306 is generally configured to use the data from learning database 304 to update (the terms update, build, create, or modify are used interchangeably herein) one or more prediction models that are then sent to prediction model database 310. Additionally, model builder 306 may also prune one or more learning models 308 to generate one or more pruned prediction models, which are stored in prediction model database 310. A pruned prediction model is generally a learning model whose input attributes have been trimmed down to a subset of attributes (or attribute values) so as to be more efficient. That is, the pruned prediction model will typically have less input attributes to affect its results than the learning model from which it has been pruned. Pruned prediction models are used by the interactive servers 302 to formulate decisions or select particular interaction paths. Of course, pruning is not necessary for practicing the techniques of the present invention and the learning or prediction model may be used without trimming the input attributes. The builder 306 may also be configured to update the one or more learning models if necessary.

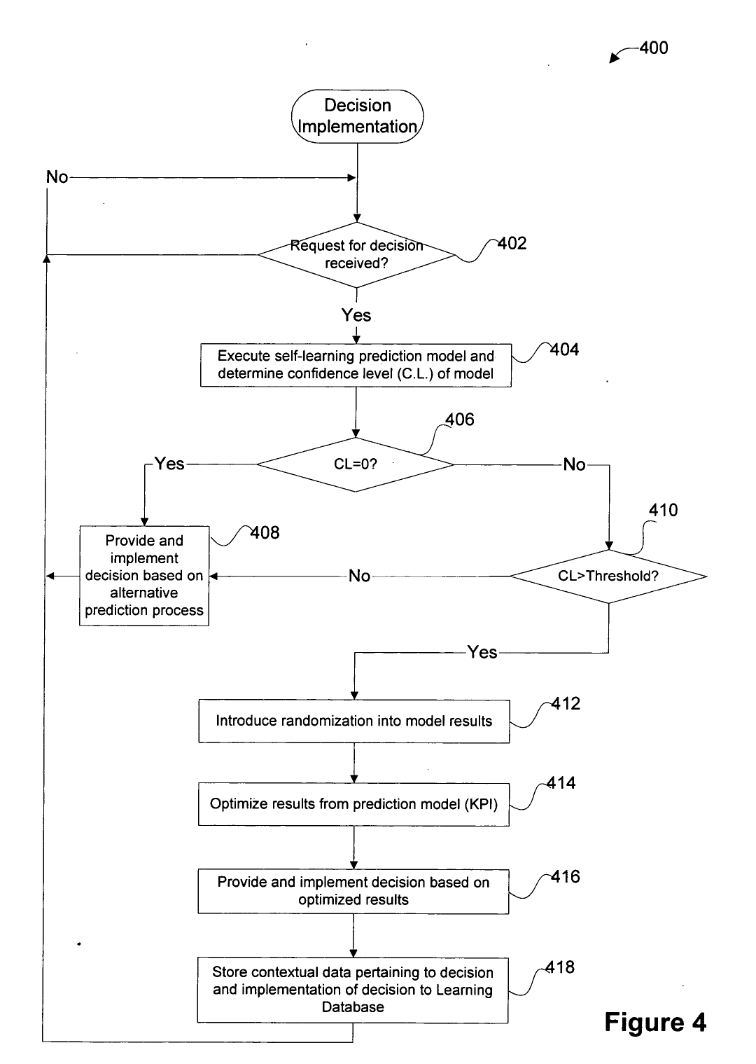

FIG. 4 is a flowchart illustrating a procedure 400 for implementing a decision using a prediction model in accordance with one example application of the present invention. The following procedure represents merely one example of a flow in which the techniques of the present invention may be implemented. In the example of FIG. 3, this procedure 400 may be executed on any one of servers 302, for example. Initially, a request for a decision may be received at operation 402. For instance, a customer may access a particular website of a company or call a company's service telephone number. The automatic process that is automatically interacting with the customer may be making a request for a particular decision regarding which web page, automated voice interaction, or particular live sales agent is to be presented to the particular customer. The request may be received at any time during the customer interaction process, e.g., at any web page in a series of sequentially presented web pages or at the beginning or at any intermediary point of an IVR telephone call. The request may also be made by a person, rather than an automatic process. For example, a sales representative may be making requests via a graphical user interface while interacting with a customer through some form of computer data exchange, such as a chat session, or a via a telephone interaction.

One or more self-learning prediction models are then executed based on the contextual data or input attributes associated with the particular decision request and a confidence level is determined for such model in operation 404. In accordance with an embodiment of the present invention, the model also preferably provides a self-evaluation process that results in a confidence level (CL) for a prediction. In cases in which a model results in multiple outcome predictions, the self-evaluation process results in multiple CL's, one for each outcome.

As noted above, the specifics of the self-learning model is not germane to the discussion of the self-evaluation process, as many types of self-learning models are compatible with the self-evaluation process of the present invention. In a specific example application, the prediction model may produce a probability value for each potential offer being accepted by the customer if such offer is presented to the customer, as well as a confidence level for each of the produced probability values.

By providing self-evaluation within the predictive model, the predictive model itself can become the switch as to the optimal path to be taken in the decision making process. The simplest case of self-evaluation is binary (yes/no), wherein it is determined whether the predictive model signals whether it should be used for prediction or not used for prediction. However, a preferred embodiment of the present invention provides a spectrum of confidence levels, ranging from zero (inclusive) to one (inclusive) on a normalized basis. By providing levels of confidence, the decision process 400 can perform its function in a more accurate and efficient manner.

The following is a description of a method for the automatic computation of model confidence level (CL) in accordance with an aspect of the present invention. It should be noted that those skilled in the art will realize that there are numerous mathematical permutations, extensions, modifications, and equivalents of the processes described below, and the following descriptions are meant to be by way of example and not limitation.

Suppose we have a model for predicting a binary outcome (A or \overline{A}). Suppose also that given a set of inputs Dᵢ this model returns a numeric score S that characterizes likelihood of the positive outcome A. The returned score S can correspond to any characteristic that correlates to likelihood of a positive (or negative) outcome. In one application, one may wish to determine the likelihood of an individual having a heart attack. In one data mining implementation, the model can determine a score in one of two ways. In a first method, the model directly determines the likelihood of a specific individual having a heart attack based on characteristics of the specific individual and past characteristics and outcomes of other individuals. That is, the score is in the form of a probability value.

In a second method, the model determines the scores of a number of factors for the specific individual and these factors each affect the likelihood of the individual having a heart attack. These factors that affect the likelihood of having a heart attack may include weight, height, whether the individual smokes, the level of exercise performed by the individual, cholesterol level, family history of heart attacks, etc. Each factor for an individual is given a score that correlates to likelihood of heart attack and this correlation is based on conventional data mining techniques. That is, a higher score correlates to a higher likelihood value. The scores for the different factors may then be compiled (e.g., added or averaged together) into a single resulting score for the specific individual. Of course, any other suitable technique for implementing a self-learning model may be utilized such as implementation of a neural network technique.

The whole range of possible values of S is subdivided into a number of small intervals Iᵢ. The number of intervals are selected so that each interval contains a statistically significant sample. Typically, there are 25˜30 intervals selected. For each of the intervals Iᵢ the models maintains the number of tests Nᵢ (i.e., the number of times a particular decision has been implemented) that resulted in SεIᵢ and the number of corresponding positive outcomes Nᵢ^{A}.

The level of model confidence is calculated as:

$$\begin{matrix}CL = max ( {\sum }_{i = 0}^{n} ( {X}_{i} - {X}_{i - 1} ) \cdot ( {Y}_{i} + {Y}_{i - 1} ) , 0 ) & \\ where \text{:} & \\ {X}_{i} = 0 for i = 0 & \\ {X}_{i} = {\sum }_{i = 1}^{i} \frac{{N}_{i}}{N} for i \geq 1 & \\ N = {\sum }_{i = 0}^{n} {N}_{i} & \\ {Y}_{i} = 0 for i = 0 & \\ {Y}_{i} = {X}_{i} - {\sum }_{k - 1}^{i} \frac{{N}_{k}^{A}}{{N}^{A}} for i \geq 1 & \\ {N}^{A} = {\sum }_{i = 0}^{n} {N}_{i}^{A} & \end{matrix}$$

In the equation for CL, above, by “max” it is meant that if the variable CL is zero or negative, that it is assigned the value zero. If it is positive, it will be in the range of 0<CL<1. However, it can never achieve the value 1, which would signify 100% confidence in a prediction.

In this embodiment, the expression

$${\sum }_{i = 0}^{n} ( {X}_{i} - {X}_{i - 1} ) \cdot ( {Y}_{i} + {Y}_{i - 1} )$$

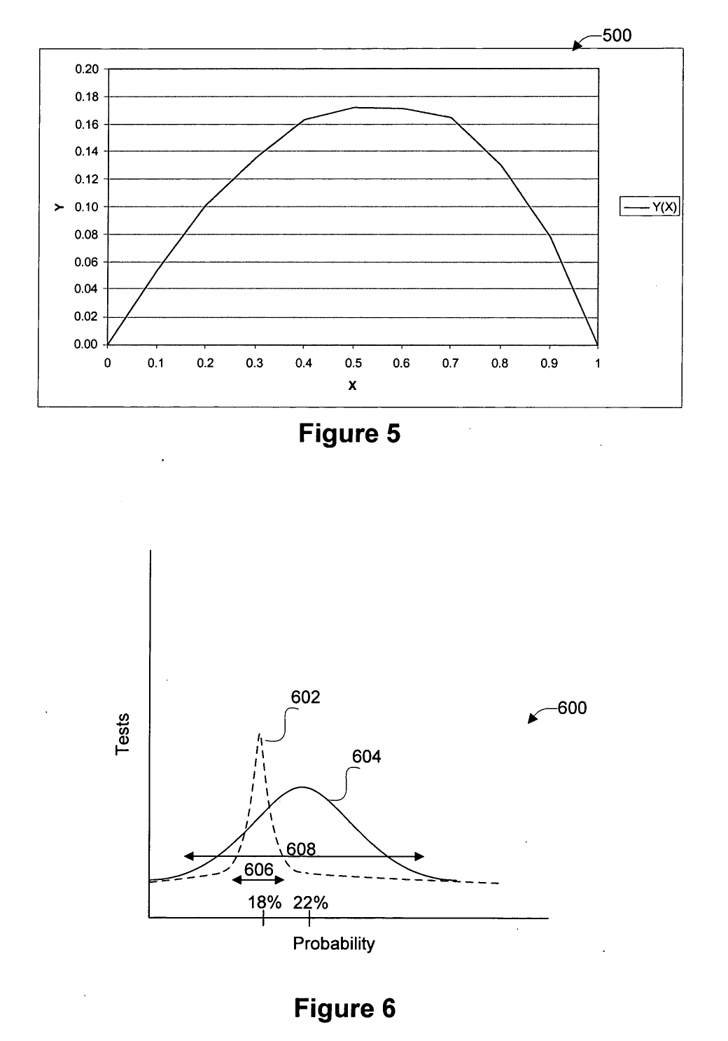

from the formula for the confidence level corresponds to the area under the curve Y(X) multiplied by two. FIG. 5 is a graph 500 illustrating an example lift curve Y(X) and determination of CL in accordance with a specific implementation of the present invention. Since Yᵢ≦Xᵢ for all values of i, the whole curve lies under the line Y(X)=X. The area under the curve is never greater than 0.5, henceforth the confidence level is never greater than 1.

The model confidence level, calculated according to the above formula, is always contained in an interval between zero (inclusive) and one (exclusive). A zero model confidence level means that the model is not able to efficiently differentiate between different sets of input data or that the model does not have enough data to predict an accurate score or probability. A model confidence level of 1 is never achieved in practice. To have confidence level measure of 1, a model would have to make exact predictions in 100% cases which, in general, is an impossibility.

With continuing reference to FIG. 4, in operation 404 the predictive model will provide a confidence level 0≦CL<1. The predictive model will also provide prediction results. It is then determined whether the determined CL is equal to zero in operation 406. If CL is equal to zero, a decision is provided and implemented based on an alternative prediction process in operation 408. For example, business rules are used to make predictions. A decision is then determined based upon the business rules results, and the decision process. The procedure 400 then waits for another decision query by repeating operation 402.

Business rules are generally compiled off-line by market research people and provided based on experience and intuition of the researchers. These rules define the likely outcome of particular decisions under specific conditions. For example, a researcher may determine that individuals from California and having an income over $100k are most likely to buy product A if presented with an offer for product A based on past experience with the buying habits of individuals from California and having an income over $100k.

Alternative prediction techniques may be used in place of a prediction model when the model is assessed as being unreliable, such as when CL equals zero. If the predictive model has a confidence level of CL>0, it may then also be determined whether CL is greater than a threshold (T) in operation 410. If the confidence level CL is not greater than the threshold T, then an alternative prediction process (e.g., a business rule technique) may be employed (instead of the prediction model) and a decision may then be based on the results produced from such alternative prediction process in operation 408.

In sum, an alternative prediction method may be substituted for a self-learning model when such model is found to have a CL that does not meet a predetermined threshold. If, however, the confidence level CL is greater than the predetermined threshold T, the model is used and randomization may also be introduced into the model results in operation 412. Several randomization processes are further described below.

The threshold T can vary from application to application and, in fact, can vary within applications. For example, the threshold for call centers may be set higher than the threshold for websites. Critical call centers, such as Platinum Customer Support Center, may have a higher threshold level than, for example, a Silver Customer Support Center. This is because it is generally desirable to have a higher confidence level for call centers before using the results of self-learning predictive models to reduce the number of erratic or poor choices presented to the call center agents, dependent upon their sensitivities to error. A typical threshold T for a call center application may be in the range of 0.2 to 0.3 (i.e. a 20%-30% confidence level).

As noted previously, a system that employs self-learning models for decision process optimization (e.g., in a business process context) has to find a balance between making decisions that maximize predicted value and decisions and the value of exploring new decisions that cannot be accurately predicted yet due to insufficient data. The later kind of decisions is required to explore the least explored options as some of them may have high value. This situation is very frequent when the alternatives to pick from have been defined at different times. In this situation, the system has to compare established options for which a lot of data has already been captured and potentially extremely recent alternatives for which very little historical data is available.

In a business application, too little exploration limits business value in the long term. It causes system stagnation and does not allow it to adapt to changes in the environment. Too much exploration, on the other hand, reduces business value in short and medium term. An embodiment of the present invention, as described below, achieves dynamic balance between the exploitation and exploration goals. It is based on models that can not only predict business value, but also estimate accuracy of their predictions.

The embodiment described with respect to FIG. 4 is easily applied to a model that predicts a single outcome, such as the probability of a particular person having a heart attack. That is, if the model does not have a high enough CL for such single prediction outcome, an alternative prediction approach such as business rules may be applied. Otherwise, the model is utilized. In other applications, a model may be configured to predict multiple outcomes. For instance, a model may predict multiple probabilities characteristics of buying different cars. In this situation, an alternative approach (e.g., business rules) may be utilized when a one of the probability characteristics is below a predetermined threshold. In another embodiment, the alternative approach may be used when all of the confidence levels for the different outcomes are below the predetermined threshold.

In a specific implementation, business rules are applied when any of the confidence levels are below the predetermined threshold in a call center environment. In a web center environment, on the other hand, outcome results that have confidence levels below a predetermined threshold may be considered unavailable and other outcome results are then used to estimate the unavailable outcome. Several embodiments of such an approach are further described in co-pending U.S. patent application Ser. No. 11/000,570 (Attorney Docket No. SIGMP002), entitled “Method and Apparatus for Determining Expected Values in the Presence of Uncertainty”, filed 30 Nov. 2004 by Michel Adar et al., which application is incorporated by reference herein in its entirety for all purposes. In this latter approach, an alternative prediction technique, such as business rules, are rarely used, e.g., they are only used when there are not enough available outcome results to estimate all of the model prediction outcomes.

A method for applying randomization as implemented by operation 412 of FIG. 4 will now be described by way of example. It should again be noted that those skilled in the art will realize that there are numerous mathematical permutations, extensions, modifications, and equivalents of the processes described below, and the following descriptions are meant to be by way of example and not limitation.

Let assume, for example, that a business decision system has to choose between possible process paths P₁, P₂, . . . Pₙ based on business value predictions V₁, V₂, . . . Vₙ. Instead of choosing the path corresponding to the highest predicted value, the selection is made based on randomized predicted values. The randomization is achieved by adding a random normally distributed term to each of the values:
Vᵢ′=Vᵢ+rᵢ
where rᵢ is a random value with a normal distribution:

$$P ( {r}_{i} ) = \frac{1}{{σ}_{i} \sqrt{2 π}} {ⅇ}^{- \frac{{r}_{i}}{2 {σ}_{i}}}$$

Standard deviation σᵢ is chosen to be proportional to an estimate of inaccuracy of prediction of Vᵢ. Standard deviation σᵢ of a predicted value Vᵢ may be estimated as:

$${σ}_{i} = {V}_{i} \frac{1}{\sqrt{{N}_{i}}}$$

where Nᵢ is the size of the statistical sample contributing to the prediction of Vᵢ.

The amount of randomization introduced into the prediction result depends on the standard deviation value or the uncertainty estimate. That is, for less certain results the result is more likely randomly deviated within a broader range of values. FIG. 6 is a graph illustrating a first probability distribution 602 for a first decision choice (e.g., the likelihood of purchasing a red car) and a second probability distribution 604 for a second decision choice (e.g., the likelihood of purchasing a brown car). The first distribution 602 shows a probability of 18% for purchasing a red car and the second distribution 604 shows a 22% probability for purchasing a brown car. The first distribution 602 for the red car also shows a narrower range 606 of deviation or uncertainty than the deviation 608 of the second distribution 604 for the brown car.

Without randomization, the brown car would always be offered to a potential customer since it is most likely to result in a sale. When the amount of randomization is higher for results that are less certain, the brown car may then periodically result in a lower probability than the red car. For instance, if the red car probability is randomly varied in a narrow range between 17 and 19% and the brown car probability is randomly varied in a wider range between 18 and 26%, the probability result for the brown car may be randomized to 18%, while the red car probability is randomized to 19%. In this situation, the red car is offered since the probability of purchase of the red car is now higher than the brown car.

The above described techniques provide mechanisms for self-evaluation of self-learning models. This self-evaluation can then be used to implement other prediction methods in place of the self-learning models when the models prove to be too uncertain. Additionally, the above described techniques include mechanisms for intelligently introducing randomization into model prediction results based on the uncertainty level of each particular prediction result.

Referring back to FIG. 4, in one implementation the prediction model may also assign values for each of a plurality of key performance indicators (“KPI's”) for each of the different decision choices (e.g., presentation of the different offers). In the sales offer example, the prediction model may output a value for a number of factors (or KPI's) that each correspond to how well a particular performance goal is expected to be met when each offer is presented. For instance, the performance goals may include both minimizing cost and maximizing revenue, as well as the probability of the offer being accepted if presented to the customer. In this example, the prediction model may determine that if a particular offer is presented it will result in $50 cost which is reflected in the “minimizing cost” KPI, an expected revenue increase of $90 for the “maximizing revenue” KPI, and a 27% value for the probability of acceptance KPI. A second offer may result in different KPI values if the second offer is presented.

Several suitable embodiments for generating a prediction model are further described in the above referenced, co-pending filed U.S. patent application Ser. No. 10/980,421 (Attorney Docket No. SIGMP004), entitled “Method and Apparatus for Automatically and Continuously Pruning Prediction Models in Real Time Based on Data Mining”, filed 2 Nov. 2004 Sergey A. Prigogin et al., which application is incorporated herein by reference in its entirety for all purposes.

The KPI values for each decision (e.g., a particular offer is presented) may then be compared in an optimization operation 414. For example, it is determined which decision to implement based on the relative importance of the various KPI's of the decisions. Several suitable embodiments of optimization techniques are described in the above referenced, co-pending U.S. patent application Ser. No. 10/980,440 (Attorney Docket No. SIGMP006), entitled “Method and Apparatus for Optimizing the Results Produced by a Prediction Model”, filed 2 Nov. 2004 by Michel Adar et al., which application is incorporated by reference herein in its entirety for all purposes.

Computer simulation has shown that optimization based on randomized predictions achieves significantly higher “lift” than an optimization based on the same predictions but without the randomization. That is, the randomization broadens the experience of the predictive model such that optimal solutions can be derived.

The selected decision is then provided and implemented based on the optimized results in operation 416. For example, the selected offer is presented to the customer. The contextual data (e.g., input attributes and results of the decision) are then stored, for example, in the learning database 304 in operation 418. Any suitable input attributes that are likely to affect the outcome of the prediction model are retained. In the sales example, a customer's demographics, sales history, and specifics of their interactions with the sales center may be retained as contextual data. After the contextual data is stored, the decision implementation procedure 400 may then be repeated for the next decision request.

In general, the present invention includes techniques for model self-evaluation and randomization introduction. These self-evaluation and randomization techniques may be implemented in any suitable environment. That is, the decision making systems described above are merely exemplary and are not necessary to practicing the techniques of the present invention. Additionally, the decision making flow described above with respect to FIG. 4 is merely exemplary and the techniques of the present invention may be utilized in any other suitable process that utilizes expected values produced by a prediction model.

The present invention may employ various computer-implemented operations involving information stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that form part of the invention are useful machine operations. The manipulations performed are often referred to in terms such as, producing, identifying, running, determining, comparing, executing, downloading, or detecting. It is sometimes convenient, principally for reasons of common usage, to refer to these electrical or magnetic signals as bits, values, elements, variables, characters, or the like. It should remembered, however, that all of these and similar terms are to be associated with the appropriate physical quantities and are merely convenient labels applied to these quantities.

The present invention also relates to a device, system or apparatus for performing the aforementioned operations. The system may be specially constructed for the required purposes, or it may be a general purpose computer selectively activated or configured by a computer program stored in the computer. The processes presented above are not inherently related to any particular computer or other computing apparatus. In particular, various general purpose computers may be used with programs written in accordance with the teachings herein, or, alternatively, it may be more convenient to construct a more specialized computer system to perform the required operations.

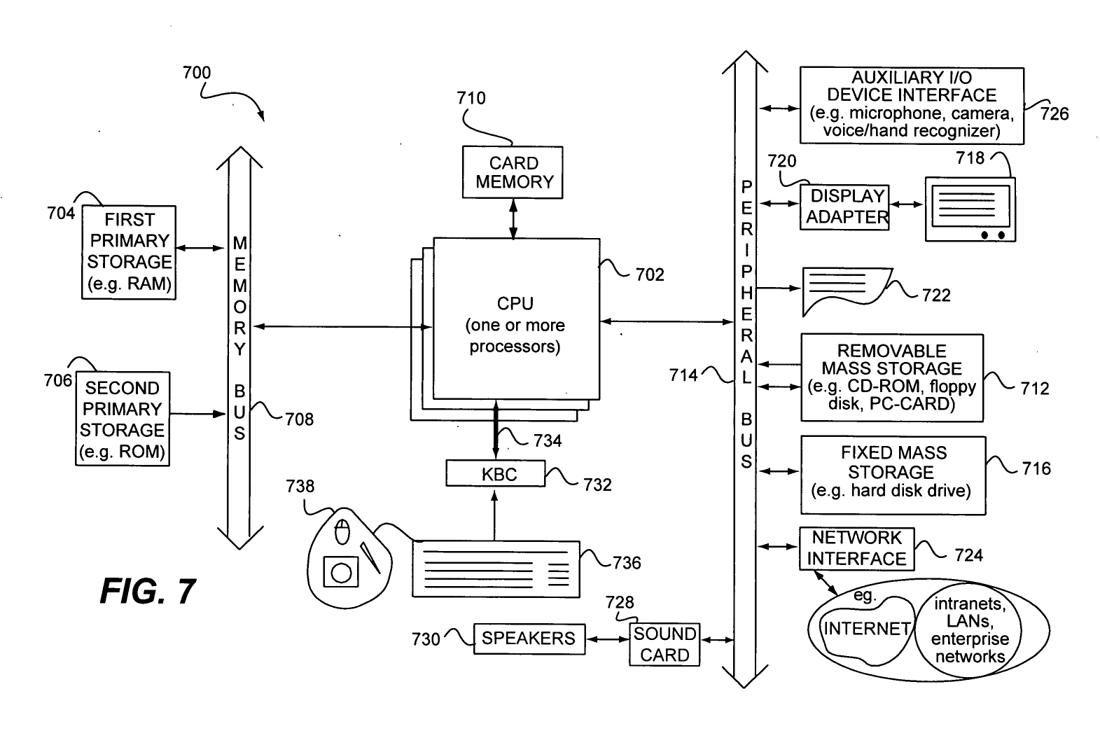

FIG. 7 is a block diagram of a general purpose computer system 700 suitable for carrying out the processing in accordance with one embodiment of the present invention. Other computer system architectures and configurations can be used for carrying out the processing of the present invention. Computer system 700, made up of various subsystems described below, includes at least one microprocessor subsystem (also referred to as a central processing unit, or CPU) 702. That is, CPU 702 can be implemented by a single-chip processor or by multiple processors. CPU 702 is a general purpose digital processor which controls the operation of the computer system 700. Using instructions retrieved from memory, the CPU 702 controls the reception and manipulation of input information, and the output and display of information on output devices.

CPU 702 is coupled bi-directionally with a first primary storage 704, typically a random access memory (RAM), and uni-directionally with a second primary storage area 706, typically a read-only memory (ROM), via a memory bus 708. As is well known in the art, primary storage 704 can be used as a general storage area and as scratch-pad memory, and can also be used to store input data and processed data. It can also store programming instructions and data, in addition to other data and instructions for processes operating on CPU 702, and is typically used for fast transfer of data and instructions bi-directionally over memory bus 708. Also, as is well known in the art, primary storage 706 typically includes basic operating instructions, program code, data and objects used by the CPU 702 to perform its functions. Primary storage devices 704 and 706 may include any suitable computer-readable storage media, described below, depending on whether, for example, data access needs to be bi-directional or uni-directional. CPU 702 can also directly and very rapidly retrieve and store frequently needed data in a cache memory 710.

A removable mass storage device 712 provides additional data storage capacity for the computer system 700, and is coupled either bi-directionally or uni-directionally to CPU 702 via a peripheral bus 714. For example, a specific removable mass storage device commonly known as a CD-ROM typically passes data uni-directionally to the CPU 702, whereas a floppy disk can pass data bi-directionally to the CPU 702. Storage 712 may also include computer-readable media such as magnetic tape, flash memory, signals embodied in a carrier wave, Smart Cards, portable mass storage devices, and other storage devices. A fixed mass storage 716 also provides additional data storage capacity and is coupled bi-directionally to CPU 702 via peripheral bus 714. Generally, access to these media is slower than access to primary storages 704 and 706. Mass storage 712 and 716 generally store additional programming instructions, data, and the like that typically are not in active use by the CPU 702. It will be appreciated that the information retained within mass storage 712 and 716 may be incorporated, if needed, in standard fashion as part of primary storage 704 (e.g RAM) as virtual memory.

In addition to providing CPU 702 access to storage subsystems, the peripheral bus 714 is used to provide access to other subsystems and devices as well. In the described embodiment, these include a display monitor 718 and adapter 720, a printer device 722, a network interface 724, an auxiliary input/output device interface 726, a sound card 728 and speakers 730, and other subsystems as needed.

The network interface 724 allows CPU 702 to be coupled to another computer, computer network, or telecommunications network using a network connection as referred to. Through the network interface 724, it is contemplated that the CPU 702 might receive information, e.g., objects, program instructions, or bytecode instructions from a computer in another network, or might output information to a computer in another network in the course of performing the above-described method steps. Information, often represented as a sequence of instructions to be executed on a CPU, may be received from and outputted to another network, for example, in the form of a computer data signal embodied in a carrier wave. An interface card or similar device and appropriate software implemented by CPU 702 can be used to connect the computer system 700 to an external network and transfer data according to standard protocols. That is, method embodiments of the present invention may execute solely upon CPU 702, or may be performed across a network such as the Internet, intranet networks, or local area networks, in conjunction with a remote CPU that shares a portion of the processing. Additional mass storage devices (not shown) may also be connected to CPU 702 through network interface 724.

Auxiliary I/O device interface 726 represents general and customized interfaces that allow the CPU 702 to send and, more typically, receive data from other devices. Also coupled to the CPU 702 is a keyboard controller 732 via a local bus 734 for receiving input from a keyboard 736 or a pointer device 738, and sending decoded symbols from the keyboard 736 or pointer device 738 to the CPU 702. The pointer device may be a mouse, stylus, track ball, or tablet, and is useful for interacting with a graphical user interface.

In addition, embodiments of the present invention further relate to computer storage products with a computer readable medium that contain program code for performing various computer-implemented operations. The computer-readable medium is any data storage device that can store data which can thereafter be read by a computer system. Examples of computer-readable media include, but are not limited to, all the media mentioned above, including hard disks, floppy disks, and specially configured hardware devices such as application-specific integrated circuits (ASICs) or programmable logic devices (PLDs). The computer-readable medium can also be distributed as a data signal embodied in a carrier wave over a network of coupled computer systems so that the computer-readable code is stored and executed in a distributed fashion.

It will be appreciated by those skilled in the art that the above described hardware and software elements are of standard design and construction. Other computer systems suitable for use with the invention may include additional or fewer subsystems. In addition, memory bus 708, peripheral bus 714, and local bus 734 are illustrative of any interconnection scheme serving to link the subsystems. For example, a local bus could be used to connect the CPU to fixed mass storage 716 and display adapter 720. The computer system referred to in FIG. 7 is but an example of a computer system suitable for use with the invention. Other computer architectures having different configurations of subsystems may also be utilized.

Although the foregoing invention has been described in some detail for purposes of clarity of understanding, it will be apparent that certain changes and modifications may be practiced within the scope of the appended claims. For instance, the following claims often use the article “a” or “an” and use of such article does not limit the claim scope to a single element. Therefore, the described embodiments should be taken as illustrative and not restrictive, and the invention should not be limited to the details given herein but should be defined by the following claims and their full scope of equivalents.

1. A method of evaluating and using a self-learning predictive model, the method comprising:
(a) receiving a request for a decision;
(b) determining confidence level of a self-learning predictive model that indicates whether the decision is to be based on the self-learning predictive model or not;
(c) providing and implementing a decision based on an alternative prediction process that is independent of the prediction model when the confidence level indicates that the decision is not to be based on the self-learning predictive model; and
(d) providing and implementing a decision based on one or more results produced by the prediction model when the confidence level indicates that the decision is to be based on the self-learning predictive model.

2. A method as recited in claim 1, wherein the confidence level is determined automatically by the predictive model.

3. A method as recited in claim 1, wherein the confidence level is a binary value having a first state that indicates that the decision is not to be based on the self-learning predictive model and a second state that indicates that the decision is to be based on the self-learning predictive model.

4. A method as recited in claim 1, wherein the confidence level is a value having a range of zero to less than 1.0, and wherein operation (c) is performed when the confidence level is less than or equal to a predetermined threshold and operation (d) is performed when the confidence level is greater than the predetermined threshold.

5. A method as recited in claim 1, further comprising executing the predictive model to thereby produce a score that corresponds to a probability of a particular outcome occurring for a set of current conditions, wherein the score is based on past outcomes under conditions that are similar to the current conditions.

6. A method as recited in claim 5, wherein the execution of the predictive model is only performed when the confidence level indicates that the decision is to be based on the self-learning predictive model.

7. A method as recited in claim 5, wherein execution of the predictive model produces a plurality of scores that correspond to a plurality of probabilities of different outcomes occurring for the set of current conditions.

8. A method as recited in claim 1, wherein the alternative prediction process is a plurality of business rules compiled by one or more people off-line from the decision making procedure.

9. A method as recited in claim 4, wherein the request for a decision originates from either an automated or a human-operated service center, and wherein the predetermined threshold is a higher value for a human-operated service center than an automated service center.

10. A method as recited in claim 1, further comprising:
executing the predictive model to thereby produce a plurality of results in the form of a plurality of scores that correspond to a plurality of probabilities of different outcomes occurring; and
introducing randomization into the scores produced by the prediction model when the confidence level indicates that the decision is to be based on the self-learning predictive model.

11. A method as recited in claim 10, wherein randomization is introduced so as to balance between exploitation and exploration goals.

12. A method as recited in claim 11, wherein an amount of the randomization of each score is proportional to an estimated inaccuracy amount of the each score.

13. A method as recited in claim 10, wherein the inaccuracy amount of the each score is a standard deviation amount of the each score.

14. A method as recited in claim 12, wherein a function of the randomization of each score is proportional to a normal distribution function with a standard deviation equal to the estimated inaccuracy of the each score.

15. A method as recited in claim 1, wherein each score is more likely deviated within a range that corresponds to a range of standard deviation of the each score.

16. A computer system operable to evaluate and use a self-learning predictive model, the computer system comprising:
one or more processors;
one or more memory, wherein at least one of the processors and memory are adapted for:
(a) receiving a request for a decision;
(b) determining confidence level of a self-learning predictive model that indicates whether the decision is to be based on the self-learning predictive model or not;
(c) providing and implementing a decision based on an alternative prediction process that is independent of the prediction model when the confidence level indicates that the decision is not to be based on the self-learning predictive model; and
(d) providing and implementing a decision based on one or more results produced by the prediction model when the confidence level indicates that the decision is to be based on the self-learning predictive model.

17. A computer system as recited in claim 16, wherein the confidence level is determined automatically by the predictive model.

18. A computer system as recited in claim 16, wherein the confidence level is a value having a range of zero to less than 1.0, and wherein operation (c) is performed when the confidence level is less than or equal to a predetermined threshold and operation (d) is performed when the confidence level is greater than the predetermined threshold.

19. A computer system as recited in claim 16, wherein at least one of the processors and memory are adapted for executing the predictive model to thereby produce a score that corresponds to a probability of a particular outcome occurring for a set of current conditions, wherein the score is based on past outcomes under conditions that are similar to the current conditions.

20. A computer system as recited in claim 19, wherein execution of the predictive model produces a plurality of scores that correspond to a plurality of probabilities of different outcomes occurring for the set of current conditions.

21. A computer system as recited in claim 16, wherein the alternative prediction process is a plurality of business rules compiled by one or more people off-line from the decision making procedure.

22. A computer system as recited in claim 18, wherein the request for a decision originates from either an automated or a human-operated service center, and wherein the predetermined threshold is a higher value for a human-operated service center than an automated service center.

23. A computer system as recited in claim 16, wherein at least one of the processors and memory are adapted for:
executing the predictive model to thereby produce a plurality of results in the form of a plurality of scores that correspond to a plurality of probabilities of different outcomes occurring; and
introducing randomization into the scores produced by the prediction model when the confidence level indicates that the decision is to be based on the self-learning predictive model.

24. A computer system as recited in claim 23, wherein an amount of the randomization of each score is proportional to an estimated inaccuracy amount of the each score.

25. A computer system as recited in claim 24, wherein a function of the randomization of each score is proportional to a normal distribution function with a standard deviation equal to the estimated inaccuracy of the each score.

26. A computer program product for evaluating and using a self-learning predictive model, the computer program product comprising:
at least one computer readable medium;
computer program instructions stored within the at least one computer readable product configured for:
(a) receiving a request for a decision;
(b) determining confidence level of a self-learning predictive model that indicates whether the decision is to be based on the self-learning predictive model or not;
(c) providing and implementing a decision based on an alternative prediction process that is independent of the prediction model when the confidence level indicates that the decision is not to be based on the self-learning predictive model; and
(d) providing and implementing a decision based on one or more results produced by the prediction model when the confidence level indicates that the decision is to be based on the self-learning predictive-model.

27. A computer program product as recited in claim 26, wherein the confidence level is determined automatically by the predictive model.

28. A computer program product as recited in claim 26, wherein the confidence level is a binary value having a first state that indicates that the decision is not to be based on the self-learning predictive model and a second state that indicates that the decision is to be based on the self-learning predictive model.

29. A computer program product as recited in claim 26, wherein the confidence level is a value having a range of zero to less than 1.0, and wherein operation (c) is performed when the confidence level is less than or equal to a predetermined threshold and operation (d) is performed when the confidence level is greater than the predetermined threshold.

30. A computer program product as recited in claim 26, wherein the computer program instructions stored within the at least one computer readable product configured for executing the predictive model to thereby produce a score that corresponds to a probability of a particular outcome occurring for a set of current conditions, wherein the score is based on past outcomes under conditions that are similar to the current conditions.

31. A computer program product as recited in claim 30, wherein the execution of the predictive model is only performed when the confidence level indicates that the decision is to be based on the self-learning predictive model.

32. A computer program product as recited in claim 30, wherein execution of the predictive model produces a plurality of scores that correspond to a plurality of probabilities of different outcomes occurring for the set of current conditions.

33. A computer program product as recited in claim 26, wherein the alternative prediction process is a plurality of business rules compiled by one or more people off-line from the decision making procedure.

34. A computer program product as recited in claim 29, wherein the request for a decision originates from either an automated or a human-operated service center, and wherein the predetermined threshold is a higher value for a human-operated service center than an automated service center.

35. A computer program product as recited in claim 26, wherein the computer program instructions stored within the at least one computer readable product configured for:
executing the predictive model to thereby produce a plurality of results in the form of a plurality of scores that correspond to a plurality of probabilities of different outcomes occurring; and
introducing randomization into the scores produced by the prediction model when the confidence level indicates that the decision is to be based on the self-learning predictive model.

36. A computer program product as recited in claim 35, wherein randomization is introduced so as to balance between exploitation and exploration goals.

37. A computer program product as recited in claim 36, wherein an amount of the randomization of each score is proportional to an estimated inaccuracy amount of the each score.

38. A computer program product as recited in claim 35, wherein the estimated inaccuracy amount of the each score is a standard deviation amount of the each score.

39. A computer program product as recited in claim 38, wherein a function of the randomization of each score is proportional to a normal distribution function with the standard deviation equal to the estimated inaccuracy of the each score.

40. A computer program product as recited in claim 39, wherein each score is more likely deviated within a range that corresponds to a range of standard deviation of the each score.

41. An apparatus for evaluating and using a self-learning predictive model, comprising:
means for receiving a request for a decision;
means for determining confidence level of a self-learning predictive model that indicates whether the decision is to be based on the self-learning predictive model or not;
means for providing and implementing a decision based on an alternative prediction process that is independent of the prediction model when the confidence level indicates that the decision is not to be based on the self-learning predictive model; and
means for providing and implementing a decision based on one or more results produced by the prediction model when the confidence level indicates that the decision is to be based on the self-learning predictive model.

42. An apparatus as recited in claim 41, further comprising:
means for executing the predictive model to thereby produce a plurality of results in the form of a plurality of scores that correspond to a plurality of probabilities of different outcomes occurring; and
means for introducing randomization into the scores produced by the prediction model when the confidence level indicates that the decision is to be based on the self-learning predictive model.
